(19) United States
(12) Patent Application Publication
(10) Pub. No.: US 2014/0246907 A1
(43) Pub. Date: Sep. 4, 2014

(54) DC PEAK POWER TRACKING DEVICES, METHODS, AND SYSTEMS

(71) Applicant: William Wilhelm, Riverhead, NY (US)

(72) Inventor: William Wilhelm, Riverhead, NY (US)

(21) Appl. No.: 14/198,491

(22) Filed: Mar. 5, 2014

Related U.S. Application Data
(63) Continuation of application No. 12/714,242, filed on Feb. 26, 2010, now abandoned.

(51) Int. Cl. H02J 9/06; G05F 3/08

(52) U.S. Cl. CPC H02J 9/06; G05F 3/08
USPC 307/23; 323/318; 307/67

(57) ABSTRACT

A control system, method, and device for managing variable power sources in DC power systems, such as photovoltaic (PV) systems. An electrical component can be configured to condition power from a photovoltaic (PV) panel such that current is drawn from the PV panel at a peak power continuously, at all times, or irrespective of current flux.

### CROSS-REFERENCE TO RELATED APPLICATIONS

This application claims the benefit of U.S. Provisional Application No. 61/156,527, filed Mar. 1, 2009. The entire content of the foregoing provisional application is hereby incorporated by reference into the present application.

### BRIEF SUMMARY

Aspects of the present invention relate generally to control systems, methods, and devices for managing variable power sources in DC power systems. In particular, aspects of the present invention involve control systems, methods, and devices for managing variable power sources in distributed systems employing power sources, such as photovoltaic (PV) systems. Even more specifically, aspects of the present invention render a low and unstable voltage into a constant output voltage, while achieving maximum peak power tracking. Aspects of the invention also involve controlling variable power sources based on one or more other variable power sources and/or one or more constant power sources.

Generally speaking, an electrical component can be configured to condition power from a photovoltaic (PV) panel such that current is drawn from the PV panel at a peak power continuously, at all times, and/or irrespective of current flux. In general, there may be three “levels” of conditioning: (1) boosting and isolating intrinsically unregulated DC PV panel voltage to a higher DC application system voltage; (2) regulating the higher isolated DC voltage so that it remains substantially stable around the system voltage; and (3) further modifying the regulated boosted panel DC voltage relative to the power system voltage so that maximum peak power tracking is achieved through influencing current flow from the PV panel.

### BRIEF DESCRIPTION OF THE DRAWINGS

The accompanying drawings illustrate embodiments of the invention. The invention will be best understood by reading the ensuing specification in conjunction with the drawing figures, in which like elements are designated by like reference numerals. As used herein, various embodiments can mean some or all embodiments.

FIG. 1 is a graph showing current versus voltage characteristics of a photovoltaic (PV) cell at a temperature of T=77° C. for various levels of incident sunlight, with current being on the vertical axis and voltage being on the horizontal axis.

FIG. 2 is a graph showing current versus voltage characteristics of a PV cell for various temperatures, with current being on the vertical axis and voltage being on the horizontal axis.

FIG. 3 is a graph showing power versus voltage characteristics of a PV cell for various solar flux rates, with power being on the vertical axis and voltage being on the horizontal axis.

FIG. 4 is a block diagram of a power control system according to embodiments of the present invention.

FIG. 5 is a block diagram of a system according to embodiments of the present invention.

FIG. 6 is side view of a system having a component coupled to a PV panel according to embodiments of the present invention.

FIG. 7 is a block diagram representation of a system according to embodiments of the present invention.

FIG. 8 is a block diagram of a distributed power system according to embodiments of the present invention.

### DETAILED DESCRIPTION

The performance of conventional green energy systems is often limited by their variability, which can make their interoperation with grid or backup power sources and/or local and distributed loads inefficient. For example, some photovoltaic (PV) systems may not match well with a conventional 60 Hz AC electricity distribution system.

A conventional PV device, such as a PV panel, is generally a passive device that typically is not connected directly to an electrical application without some form of power conditioning to render it compatible with electrical applications.

For extreme conditions of solar exposure, the PV device may have, under full solar intensity, for example, an output voltage that is too high and thereby potentially destructive to the electrical application. Conversely, under low levels of solar illumination, for example, the PV device may stop functioning altogether.

To address the overvoltage problem, a PV power source may be connected in parallel with a voltage sink or combination sink and source, such as a chargeable DC battery. Current flows from the PV device to the battery at the terminal voltage of the battery, i.e. at a voltage determined by the battery, rather than a peak performance characteristics of the PV device. This arrangement can regulate the voltage by limiting the voltage to a predefined level until the battery approaches full charge, at which point it may not be able to handle the current. The PV device may then be disconnected from the battery. A charge controlling device interposed between the PV device and the battery may be used to prevent overcharging.

Aside from voltage, other factors can limit the performance of a PV device. For example, the peak power output potential of a PV device may be unrealized. This can be overcome by employing a Maximum Peak Power Tracker (MPPT) to identify and control operation at the maximum peak power output point of the PV device.

PV devices may also be hampered by issues relating to locations and sub-array interconnections, particularly when shadowing differentially affects series-connected PV devices. These problems may be accentuated when many individual PV devices are series connected to achieve higher voltages. Shadowing of a portion of the PV device effectively may reduce the flow of electrical energy for all of the series connected panels in the system. Connecting in parallel, as discussed in embodiments of the present invention, can minimize this problem, but output voltage and peak power tracking may also be desirable.

Embodiments of the present invention include a device which can include circuitry integrated into a PV device, such as a PV panel, to raise or increase a common, unregulated low DC voltage of the PV panel to a higher, regulated system-level voltage. Peak power may be tracked based on feedback. For example, a signal indicating the temperature of PV cells within the PV panel may be used.

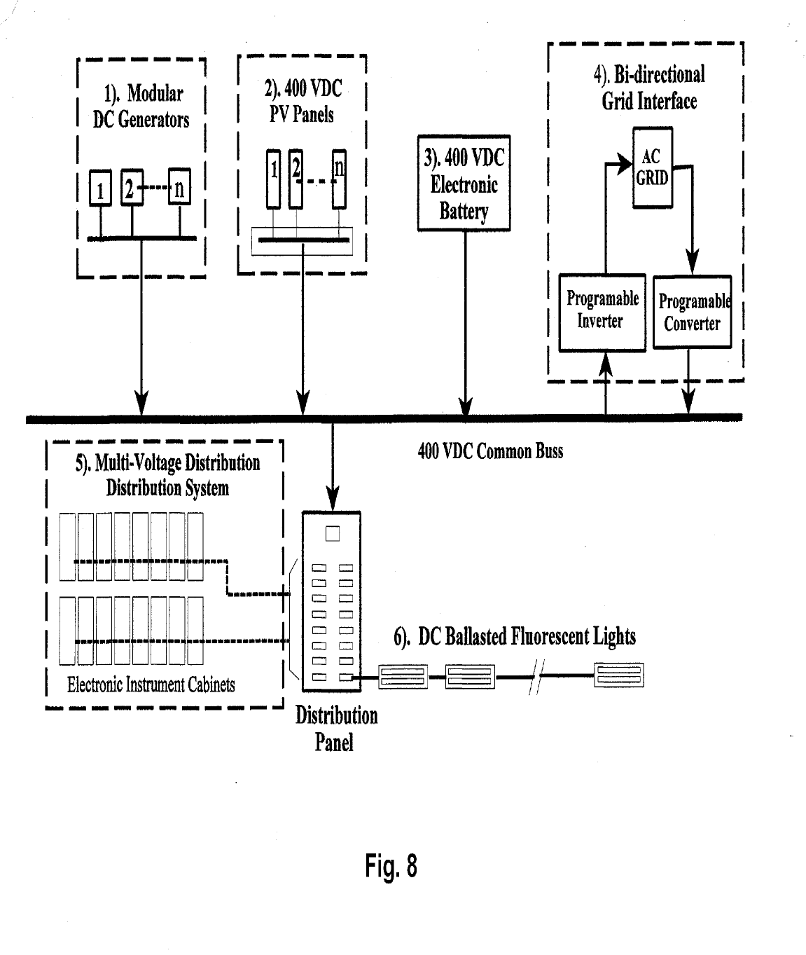

Embodiments of the present invention also include mechanisms for parallel connection of PV devices. Optionally or alternatively, embodiments of the present invention also include parallel connection of one or more PV devices with one or more “steady” power sources, such as an AC grid. FIG. 8, for example, shows a distributed power system having a plurality of power components coupled to a common DC bus. Some or all of these components can be coupled in parallel with each other. Some or all of the components coupled in parallel may assist with regulation of output power, such as peak output power, for one or more other power components. For example, outputs of two “DC” power components, such as a PV device and an AC grid having an output thereof converted to DC, are connected in parallel. In order to modify the power output of one of the power components, a characteristic of the other power component can be modified, such as the output voltage. In embodiments of the present invention, a minor or subtle modification in the output voltage, for example, of one power is made, thereby modifying the output voltage of the other power component in correspondence with the first power component. As a practical example, for a variable power output device, such as a PV device, coupled in parallel to a steady power outputting device, the PV device may “take over” in outputting all of the power requirements for load during sunny periods, whereas the steady power output device may take over all of the power requirements for the load at night or when cloudy, for example. Such transition is performed continuously. As another practical example, aspects of the present invention can include a DC distribution subsystem that contains one or more DC generator to supplement the output of one or more PV panel responsively to load conditions. Such an arrangement may be implemented during shaded periods for the PV panel.

In embodiments of the present invention, a high voltage PV device boosts the normally low DC output voltage of the PV device to a higher DC output voltage and regulates the operating voltage for peak current, peak PEC current for example. This feature can make it unnecessary to connect PV devices, such as PV panels, in series to achieve high transmission voltages at the optimum system level, while simultaneously permitting smaller gauge wiring to be utilized.

Embodiments of the present invention can include means for altering an electrical characteristics of a PV device, such as a PV panel, to enable it to produce electrical power optimally. This can be accomplished by integrating electronic circuitry within the structure of the PV device so as to boost the DC voltage to a higher level corresponding to the system distribution voltage, and providing maximum peak power tracking based on a temperature of the PV device.

Generally speaking, for the PV device according to embodiments of the present invention, the high voltage output that is produced can be regulated at the system level, with additional feedback control provided, to automatically make fine adjustments above and/or below the electrical system voltage level. Such fractional voltage control can influence the proportion of current delivered by the PV device relative to a main power source. Increasing the PV device's high voltage output to higher than the system voltage can cause more current to flow from the PV device into the electrical power system. Conversely, decreasing the PV device's high voltage output below the system voltage can cause less current to flow into the electrical power system. For example, it may be possible to interrupt current flow completely from this PV device, without mechanical switching, by changing voltage downward from the PV device's power supply in a 400 VDC system, for example. Minute changes in the PV device's high voltage output can be sufficient to control a full range of potential electrical currents the device can produce.

In embodiments of the present invention, PV device (e.g., PV panel) temperature can be used as a principal means for achieving maximum peak power point operation. Colder temperatures can raise the peak power point voltage operation, while hotter temperatures reduce it. Since PV cell current of the PV panel and cell temperature can typically be dominant properties that affect the peak power point, embodiments of the present invention can include the means for dynamically adjusting PV panel high voltage output such that the resulting PV cell current is not greater than is required to support operation at the peak power point. Optionally or alternatively, the means for dynamically adjusting PV panel high voltage output can so adjust such that the resulting PV cell current is not less than is required to support operation at the peak power point. This can be accomplished by comparing, electronically for example, the low terminal voltage of the PV panel with the expected known voltage of the peak power point and using the resulting signal to guide the voltage booster to deliver an output voltage and current to the electrical system that insures optimum power operation.

The known peak power voltage of a silicon PV cell remains essentially constant throughout the range of solar exposure, down to about 5% of maximum solar intensity.

FIG. 1 shows current versus voltage of a PV cell at a temperature of T=77° C. for various levels of incident sunlight. The peak power point for every curve is essentially at the same voltage as indicated by the line 100 which passes through the approximate peak power point (current multiplied by voltage) of each curve.

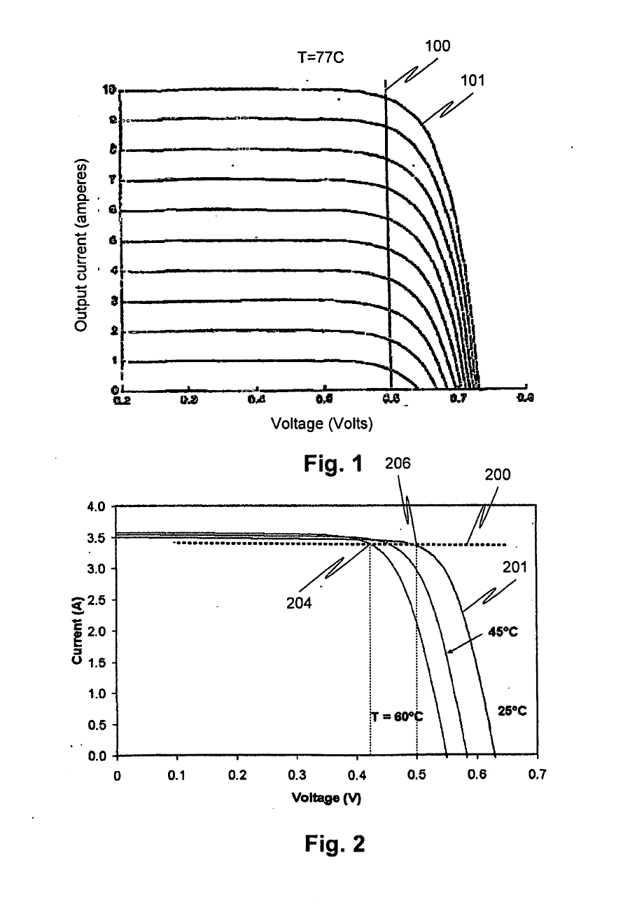

FIG. 2 is a graph showing current versus voltage characteristics of a PV cell for various temperatures, with current being on the vertical axis and voltage being on the horizontal axis. FIG. 2 illustrates how the voltage coinciding with the peak power point changes with temperature. The lines 201 each indicate the current versus voltage characteristic of a PV cell for a respective temperature. The line 200 indicates the peak power point. As can be seen, the voltage coinciding with the peak power point for each temperature curve is different. For example, the point 204 indicates a peak power voltage of about 0.42 volts at 60° C. while at 25° C., the peak power point 206 is about 0.50 volts.

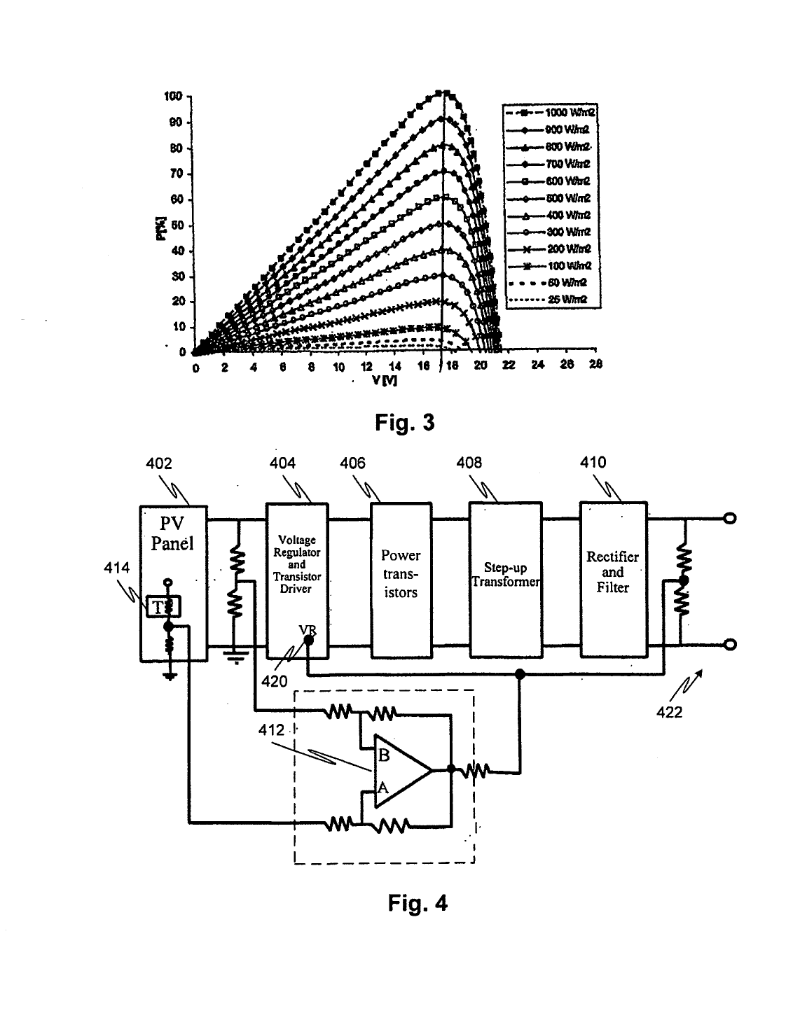

FIG. 3 is a graph showing power versus voltage characteristics of a PV cell for various solar flux rates, with power being on the vertical axis and voltage being on the horizontal axis. As can be seen from FIG. 3, the voltage that coincides with peak power is relatively independent of the flux.

FIG. 4 is a block diagram of a power control system according to embodiments of the present invention. FIG. 4 illustrates a power control system in which a photovoltaic panel 402 generates a voltage which is detected and applied to an input B of a comparator 412. A temperature sensor 414 also generates a voltage that is applied to another input A of the comparator 412 such that an error signal is generated at its output and used to regulate a voltage regulator of a voltage boosting circuit. The voltage boosting circuit may include power transistors 406, a transformer 208 or equivalent device for raising an AC voltage, and a rectifier 410. The power control system in FIG. 4 also can include a voltage regulator and transistor driver 404.

Note that in all the embodiments, instead of PV, the variable power source may be wind energy or any other variable, preferably renewable power source.

It can be a function of a feedback control system in a high voltage boost regulator, according to embodiments of the present invention, to use the level of the voltage to insure that PV panel current output does not depart at all from or above or below by a predetermined amount from the value establishing peak power operation while supporting the power system. The set point for the known peak power voltage can be derived from a temperature sensor, the output of which can be fed into one input of a comparator circuit. The other input to the comparator circuit can be unregulated PV panel voltage. The difference between the two signals is an indication of a departure from maximum peak power operation. The signal is called an “error signal” and can be used to cause the voltage regulator to raise or lower the high-side voltage output from the PV panel so as to influence the maximum peak power current extracted from the PV panel.

Embodiments of the present invention can comprise three functional components to achieve maximum peak power tracking. For example, aforementioned three functional components can include a voltage booster with high voltage regulation; a comparator circuit to identify and control maximum peak power point of operation; and a means for tracking the PV cell temperature of the PV panel, for example, in order to establish the maximum peak power point.

The voltage boosting high voltage regulator can be configured for one or both of fixed and variable voltage regulation. The fixed voltage regulation function can keep the high voltage output of the PV panel at the approximate voltage of the electrical system it is supplying, while the variable regulation function can make small adjustable changes in the high-side voltage output above and/or below the fixed voltage setting. The variable voltage can be used to control the amount of current delivered by the PV panel to the electrical system in order to achieve maximum peak power operation. Put another way, the system can nominally regulate for a high voltage, such as 400 VDC and micro regulate above or below the high voltage, for example relatively small changes to 401 VDC.

Both of the aforementioned regulation functions can achieve the desired result: providing an appropriate signal voltage level on the voltage regulating terminal (“VR Terminal”), which can be located on the integrated circuit, and can be used to control operation of the voltage boosting high voltage regulator. The fixed voltage signal level can be determined by the center point of a voltage divider that is connected across the high-side voltage output of the PV panel.

Similarly, the variable voltage regulation function can be determined by the voltage from the output of a differential amplifier/comparator. The differential amplifier/comparator compares the voltages at its input terminals and respectively raises or lowers its control voltage output voltage (marked “C”) depending on the difference between the voltages of its two input points (marked “A” and “B”).

PV panel temperature can be determined by a voltage divider network having, for example, a fixed resistor and a temperature sensing thermister connected in series. Optionally, the voltage divider network can consist of a fixed resistor and a temperature sensing thermister. An output of the voltage divider network can be connected to the “A” side of the differential amplifier/comparator. The output of the voltage divider network can be used to product an output of the differential amplifier/comparator, which can establish the targeted set point of the peak power voltage for all operating temperatures of the PV panel. This set point can establish the optimum characteristic voltage at which the PV cell delivers maximum peak power output performance. The set point is constantly changing with PV panel temperature. This set point can be correlated to the target voltage for maximum peak power operation of the PV panel. The temperature indication voltage divider network can be positioned at the back of the PV panel, for example, in contact with the substrate of the PV cells. Of course the voltage divider network can be positioned at any suitable position on the PV panel, such as the back (as mentioned above), the front, the top, the bottom, one or more sides, at an interior of the panel (e.g., inside of a housing), or at an exterior arrangement (e.g., outside a housing). The PV panel temperature may be a principal parameter for determining the desired peak power point voltage.

The “B” side of the differential amplifier/comparator can be connected to a low voltage side of the PV panel, for example. For example, the “B” input of the differential amplifier/comparator can be coupled between two resistors coupled in series, wherein one of the resistors is coupled to the high-side output of the PV panel and the other of the resistors is coupled to the low-side output of the PV panel (e.g., ground). It is effectively the characteristic operating voltage of the panel, or, more specifically, a representation of the PV cell voltage of the series of cells that make up the electrical construction of the PV panel. If, for example, the “B” side voltage at the differential amplifier/comparator is less than that the “A” side, it can mean that the PV panel is overloaded and the output of the PV panel is being drawn down below its optimal output voltage point. Under these circumstances, the voltage at the output of the differential amplifier/comparator decreases, causing the voltage at the voltage regulating terminal (“VR”) to also decrease. This results in a decrease on the high voltage of the voltage boosting high voltage regulator output. By decreasing the high voltage output in response to these conditions, less current can be delivered to the power system and less current is extracted from the PV panel, thereby bringing it closer to its maximum peak power point of operation. When the optimum level of output voltage and current are reached, maximum peak power point operation is achieved.

If the voltage on the “B” terminal is higher than the “A” terminal, the voltage that is impressed upon the voltage regulating terminal (“VR”) will increase and the output of the high voltage regulator will increase, causing more current to flow from the PV panel to the power system.

The error correction process will settle at a control point where the voltage difference of the differential amplifier/comparator input terminal is zero or close to zero. This is the point of maximum peak power point operation.

For embodiments of the present invention, high voltage DC is derived from an otherwise low voltage DC PV panel by using the power produced at its terminals to energize an alternating current, high frequency (30 to 200 kHz) electronic power oscillator (not shown). This oscillator is coupled to a step-up transformer 408 that boosts the AC voltage to a higher level. This higher level AC voltage is then full-wave rectified to render it DC and filtered to remove undesirable ripple. Rectifier and filter circuitry or components 410 can be used to rectify and filter the AC voltage. The resulting DC output voltage can be further maintained electronically at or approximately at the system voltage as defined by the power system it supplies.

To achieve voltage regulation according to embodiments of the present invention, an integrated circuit component configured to modulate the power level of the oscillator so that the desired output voltage level is achieved. This integrated controller can have a contact terminal (“VR”) in its design that can receive a signal voltage that can be used to determine the output voltage of the voltage regulator. The signal voltage can be derived from a voltage divider that directs the level of the high voltage output of the PV panel.

Aspects of the present invention also include a voltage booster and regulator that uses zero crossover resonant switching circuits with two isolated and separate high frequency power sections, such that one phase can be phase shifted relative to the other, but driven by the same “on-frequency” source. Two separate sections can be summed together on secondary windings of the step-up transformers for loss-less voltage control by altering the phase relationship of one of the two summed sinusoids. The resulting combined sinusoid voltages then becomes the sum or difference of the two wave shapes. The resulting AC output can then be rectified and filtered for delivery to an electrical load. Voltage output can be affected by an optically isolated feed back loop that compares the output voltage with a set point and causes a phase shifting circuit to drive one AC section with a delay that corresponds to the voltage required at the output of the power section. Put another way, voltage regulation can be performed without using pulse width modulation.

To provide this regulated high voltage PV power supply with maximum peak power tracking functions, the same voltage regulating contact terminal on the controlling integrated circuit can be used to superimpose a component of control that further alters the set point voltage. An additional feedback signal can cause the high voltage output to rise or fall in small increments in response to the location of the maximum peak power operating point. This additional controlling information is derived from the output of an electronic comparator 412 that takes the two signals and compares them. Depending on which signal is higher relative to the other, a small correction voltage is produced resulting in a change in high voltage output that that has the effect of delivering either more or less current to the system.

For embodiments of the invention, the differential comparator can be used to determine the current that should be extracted from the PV cells in order to achieve maximum pear power tracking. The voltage derived from is two inputs causes its output to change as a function of operation conditions such that it can direct, the voltage booster and regulator, to alter its output voltage to the electrical load power bus such that it only extracts enough current from the panel to remain at the peak power point. This voltage may be directed slightly higher or lower relative to the system “set voltage” equal to the voltage of the power buss supporting the electrical application and the available energy from the sun.

One of the signal level inputs causing change is derived from a temperature sensor voltage divider 414 which can represent the precise PV extraction voltage defining the maximum peak power point for all temperatures of the PV panel. The other input can represent the output voltage of the PV panel before voltage boosting (i.e., before regulating). The comparison of the two input signals can produce an error voltage that determines the degree to which the signal at VR needs to be corrected. Correction in this instance means that the output voltage of the PV panel is either increased or decreased to cause PV electrical energy to be drawn from PV cells at just the preferred level.

It is understood that the final circuit details incorporated into this application may differ from the one shown in FIG. 4 in this disclosure but with the same intended result. Furthermore, it is universally understood that the maximum peak power operating point of a PV panel can be achieved when current is extracted from it and power is delivered at an optimum level. This specific level corresponds to the point at which the PV panel voltage and current are at their maximum for any expected environmental condition.

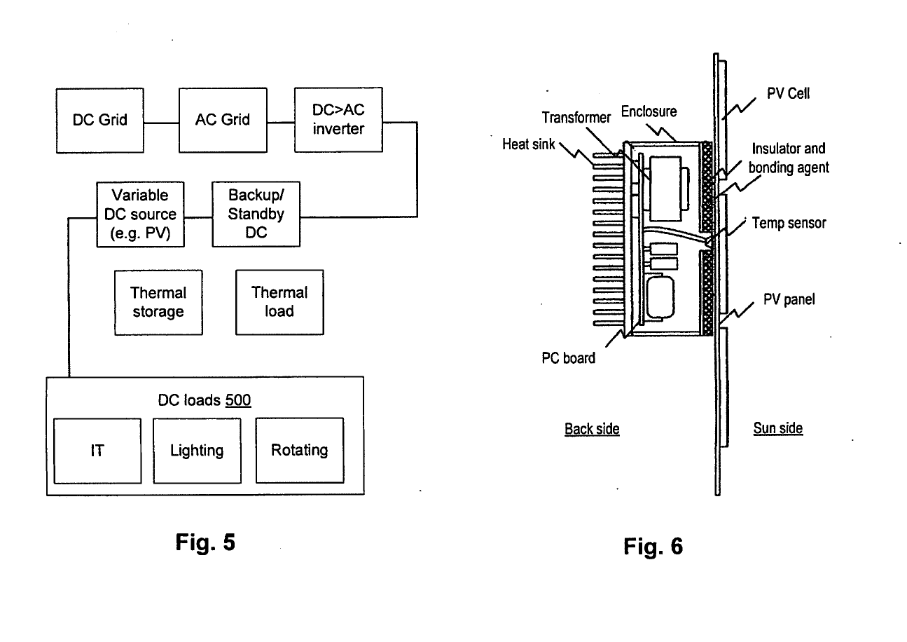

FIG. 5 illustrates a system integrating the variable DC source with various system components. The system supplies power at a DC voltage of 400 volts to various loads 500, including information technology elements including data centers, rotating machinery, and lighting. In modern systems, all of these loads are DC loads and any conversion components required to change AC to DC (as typically provided in AC appliances such as air-conditioning) can be bypassed and the DC provided directly to the load. Examples are brushless motors, lighting, and computer equipment.

FIG. 6 is side view of a system having a component coupled to a PV panel according to embodiments of the present invention. The component can provide an output matched to the voltage requirements of the system. The component can be modular and attachable to the PV panel and may include all or a portion of the elements needed to control the panel voltage to match the system supply voltage and the peak power tracking function.

For embodiments of the present invention, the temperature of the PV panel can be one of the most or the most important parameter affecting the location of the maximum peak power point. The temperature of the PV panel may be derived through direct contact with a substrate supporting the PV cells in the panel. Other means for deriving cell temperature may also be applied, such as infrared sensing of cell temperature. It is also understood that the maximum peak power point may differ depending on the semiconducting material used in the PV cell.

Maximum peak power tracking for PV systems and arrays can be performed by any suitable means, in any suitable way. For embodiments of the present invention, the temperature of the PV panel may be measured, sensed, or otherwise derived using any suitable means, for example by using a thermister in series with one or more fixed resistors to form a voltage divider. The voltage at the center of the divider relative to the circuit reference (“ground”) can correspond to the temperature signal.

The applicability of these embodiments may depend upon the connection of the high voltage PV panel with a companion high voltage DC power supply. This companion DC power supply must be a stable source of DC power that is capable of supplying an electrical power application. The companion DC power supply is the reference power producer for the DC power system, augmented by the parallel connected PV panels of this embodiments. The reference DC power supply delivers a voltage corresponding to the operating voltage of the system.

An application example will help to clarify the operation of this multiple power supply support structure. Consider a DC power system where the primary power source is a 400VDC, voltage-regulated, engine-generator supporting a DC compatible, electronically-ballasted fluorescent lighting system. Such a system may be used in a large building such as a supermarket or office building. The engine-generator has a low internal resistance and is capable of producing a stable DC voltage.

Connected in parallel with the DC engine-generator are the high voltage PV panels that also supply electric power to the DC electrical system. The enhanced PV panel of these embodiments is expected to deliver superior performance over conventional PV panel and system designs. Its superiority is demonstrated by its capability to produce a stable DC voltage that is consistent, for example, with a building electrical system such as that which is used in an electronic Data Center with DC compatible electronic fluorescent lighting; DC compatible variable frequency driven HV AC systems; and racks of electronic devices such as computers.

Efficient transmission of electrical power from parallel-connected PV panels is assured by their production of high voltage DC electricity. In addition, costly power conditioning is avoided by directly connecting the high voltage DC electricity generated by the PV panels with its companion DC power supply directly to the power application. Maximum power delivery from the PV panels is also provided by a simple and effective power sharing scheme where the proportion of current delivered from individual, parallel connect, power supplies is influenced by their respective output voltages.

This system approach insures reliable and fail-safe operation with multiple, independent and parallel-connected PV panels and companion power sources. It also ensures that PV panels of various sizes and from different manufacturers can share the same power system circuitry. The net result of these combined features is a significantly improved PV assisted power system and a more cost effective means for integrating multiple sources into a power delivery system.

As described above, the DC voltage supply can include back up generators or other back up sources such as DC or AC sources. Waste heat may be recovered from systems, such as PV panels or equipment such as condensers and used to offset or supply thermal loads.

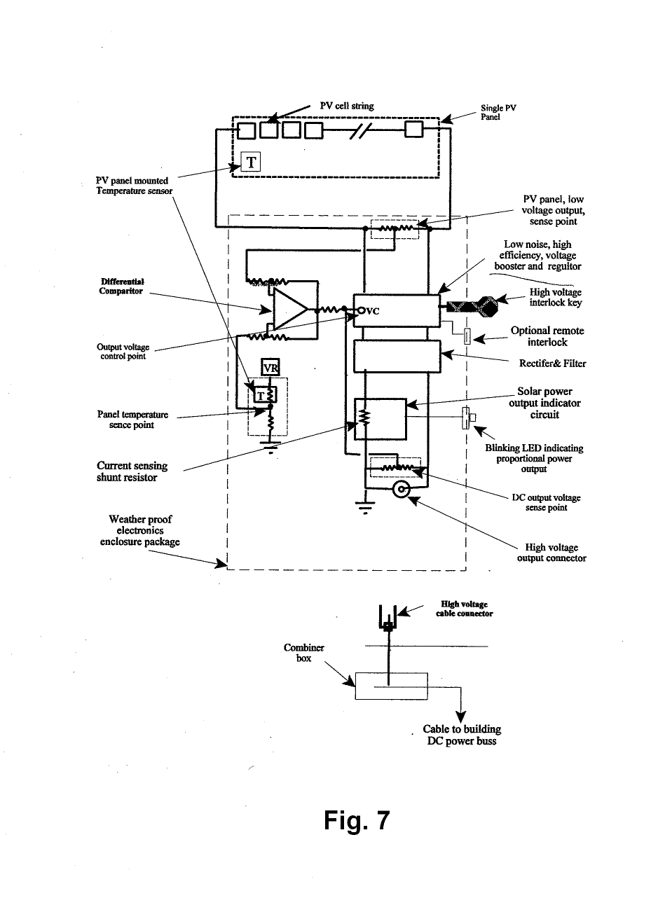

FIG. 7 is a block diagram representation of a system according to embodiments of the present invention.

FIG. 8 is a block diagram of a distributed power system according to embodiments of the present invention.

While the present invention has been described in conjunction with a number of embodiments, the invention is not to be limited to the description of the embodiments contained herein, but rather is defined by the claims appended hereto and their equivalents. It is further evident that many alternatives, modifications and variations would be or are apparent to those of ordinary skill in the applicable arts. Accordingly, all such alternatives, modifications, equivalents, and variations that are within the spirit and scope of this invention.

1. A photovoltaic (PV) panel device with power conditioning features, comprising:
a circuit configured to increase a voltage of the PV panel to an output voltage;
an electronic power conditioner integrated into the PV panel which also includes a temperature sensor;
the circuit being further configured to regulate the output voltage responsively to the temperature sensor such that current is drawn from the PV panel at a peak power irrespective of a current insolation flux;
wherein the power conditioner is connected in parallel to other power conditioners which are then connected to at least one backup power generator and a backup battery including a battery.

2. The device of claim 1, wherein the output voltage is at least 200 volts.

3. The device of claim 1, wherein the circuit is further configured to regulate a current of the output of the PV panel by varying the output voltage.

4. The device of claim 1, wherein the temperature sensor is in direct contact with a substrate supporting one or more PV cells.

5. The device of claim 1, wherein the circuit is further configured to regulate current temperature sensor responsively to an error signal responsive to an output voltage of the PV panel and a signal of the temperature sensor.

6. The device of claim 1, wherein the output voltage is nominally 400 VDC.

7. The device of claim 1, wherein the power conditioner is connected in parallel to other power conditioners which are then connected to DC loads.

8. The power conditioner of claim 1, wherein the power conditioner is connected in parallel to other like power conditioners which are then connected to at least one backup power generator.

9. The power conditioner of claim 1, wherein the power conditioner is connected in parallel to other like power conditioners which are then connected to DC loads, a backup power generator including a battery.

10. The power conditioner of claim 1, in which safety circuitry is included within the PV panel structure that prevents the activation of the PV panel until an electric load of a predefined maximum resistance or less is connected to the output of the PV panel.

11. The power conditioner of claim 1, further comprising a high voltage external disconnect means between a load and the PV panel which is configured to open when the circuit resistance that is greater than a predefined maximum, thereby causing the PV panel output voltage to go to zero.

12. An electrical component configured to condition power from a photovoltaic (PV) panel such that current is drawn from the PV panel at a peak power substantially at all times during operation, the component comprising:
circuitry to increase an unregulated DC voltage from the photovoltaic (PV) panel;
circuitry to regulate the increased DC voltage for output; and
circuitry to modify the regulated and increased DC voltage for output, the circuitry to modify including a comparator that receives a first voltage signal from a temperature sensor representative of a temperature of the PV panel and a second voltage signal associated with the unregulated DC voltage, the circuitry to modify superimposing on the regulated and increased DC voltage a secondary voltage that causes the regulated and increased DC voltage to one of rise or fall, the rising or falling of the regulated and increased DC voltage causing current extracted from the PV panel to be altered.

13. The electrical component of claim 12, wherein the electrical component is integral to the PV panel.

14. The electrical component of claim 12, wherein the electrical component is part of a DC-based distributed power system.

15. The electrical component of claim 12, further comprising an optional diagnostic circuit component to indicate the relative output power of the PV panel as a measure of operating performance.

16. The electrical component of claim 12, further comprising a safety interlock for preventing or minimizing shock hazards by at least one of preventing the PV panel from being energized during shipping and installation until a special key is removed to activate the PV panel and remotely causing the PV panel to be de-energized.

17. A method comprising:
receiving an unregulated DC voltage signal from a PV panel; and
increasing the unregulated DC voltage signal to an output voltage; and
continuously regulating the output voltage responsive to a temperature sensor output so as to draw out current from the PV panel at a peak power.

18. The method of claim 17, wherein said continuously regulating further includes peak power tracking and incrementally raising or lowering the increased regulated output voltage based on a voltage associated with the unregulated DC voltage signal.

19. The method of claim 17, wherein the method is implemented for each for a plurality of PV panels connected in parallel.
